(19) United States
(12) Patent Application Publication
(10) Pub. No.: US 2021/0158248 A1
(43) Pub. Date: May 27, 2021

(54) COMPUTER SYSTEM AND RESOURCE MANAGEMENT METHOD

(71) Applicant: Hitachi, Ltd., Tokyo (JP)

(72) Inventors: Ryo UENISHI, Tokyo (JP); Takaki KURODA, Tokyo (JP); Hiroshi HAYAKAWA, Tokyo (JP); Masashi YAKU, Tokyo (JP); Hironobu SAKATA, Tokyo (JP)

(21) Appl. No.: 17/007,106

(22) Filed: Aug. 31, 2020

(30) Foreign Application Priority Data
Nov. 26, 2019 (JP) 2019-213270

(51) Int. Cl. G06Q 10/06; G06F 7/575

(52) U.S. Cl. CPC G06Q 10/06312; G06F 7/575; G06Q 10/06315

(57) ABSTRACT

A computer system includes a business system operating services each providing a function corresponding to a request. the computer system comprises: a controller generating a schedule for changing an allocation amount of a resource of the business system for a service; and an allocation change unit changing the allocation amount of the resource for the service based on the schedule. The controller calculates in a case of detecting reception of a request for starting processing, a reception count of the detected request; identifies related services; calculate a predicted value of an index indicating a load of each of the related services based on the reception count of the request; determines whether it is necessary to change the allocation amount of the resource for the each of the related services; and generates the schedule of a determined related service.

### CLAIM OF PRIORITY

The present application claims priority from Japanese patent application JP 2019-213270 filed on Nov. 26, 2019, the content of which is hereby incorporated by reference into this application.

### BACKGROUND OF THE INVENTION

This invention relates to a method of managing resource allocation in microservices.

In recent years, the use of systems (microservices) that combine a plurality of services to implement various functions has been expanding. In general, the services are implemented by using a container technology. The container technology is a virtualization technology that uses the resources of one physical computer to operate a plurality of applications, and is a technology of providing an application execution environment that is isolated on an operating system (OS) operating on one physical computer. Herein, the isolated application execution environment is referred to as a “container.” Containers have the characteristics of being light and starting quickly.

Microservices use the characteristics of containers to implement load distribution and efficient resource usage by adjusting the number of containers in accordance with the load of the service.

The technologies described in JP 2017-219972 A and JP 2011-118525 A are known as technologies of changing resource allocation in accordance with the load in a system configured to execute a plurality of applications by using the resources of a physical computer.

In JP 2017-219972 A, it is described that “A computer program causes a computer system capable of changing the number of processing nodes executing a plurality of processes by distributing the load to monitor the load of a first process. When the load of the first process exceeds a first condition, the computer program causes the computer system to transfer, via a network, a processing program for executing a second process relating to the first process to a processing node added in order to execute the second process.”

In JP 2011-118525 A, it is described that “A load information collection unit collects the loads of a physical server and a virtual server, and stores each load in a load information table as load information in association with the time at which the load is collected. A similar load information selection unit selects past load information similar to the load at the current time from the load information table when the load to be managed deviates from a scale-out threshold value or a scale-in threshold value. A scale-out determination unit or a scale-in determination unit assumes that the load to be managed is to be changed in accordance with the selected load information, and when it is predicted that the load to be managed continues to deviate from any one of the threshold values, execute scale-out or scale-in.”

### SUMMARY OF THE INVENTION

In the technology described in JP 2017-219972 A, a processing node is added in response to an increase in load, and therefore it is not possible to execute scale-out or the like (change the amount of resources allocated to the service) before an influence on the service becomes apparent. In the technology described in JP 2011-118525 A, the load is predicted based on a history of past loads, and therefore it is not possible to handle load fluctuations that do not exist in the history, for example, a sudden increase in load.

This invention is to provide a technology for changing a resource allocation amount for a service in various situations before an influence on the service becomes apparent.

A representative example of the present invention disclosed in this specification is as follows: a computer system comprises a plurality of computers. The plurality of computers each includes an arithmetic device, a storage device coupled to the arithmetic device, and a communication device for coupling to an external apparatus, the communication device being coupled to the arithmetic device. The computer system includes a business system including at least one of the plurality of computers, the business system is configured to operate a plurality of services each providing a function corresponding to a request. The computer system comprises a controller configured to generate a schedule for changing an allocation amount of a resource of the business system for a service, and an allocation change unit configured to change the allocation amount of the resource for the service based on the schedule. The controller is configured to: calculate, in a case where reception of a request for starting processing is detected, a reception count of the detected request; identify a plurality of related services to be executed based on reception of the detected request; calculate a predicted value of an index indicating a load of each of the plurality of related services based on the reception count of the detected request; determine whether it is necessary to change the allocation amount of the resource for the each of the plurality of related services; and generate the schedule of a determined related service.

According to at least one embodiment of this invention, in various situations, a resource allocation amount for a service can be changed before an influence on the service becomes apparent. Other problems, configurations, and effects than those described above will become apparent in the descriptions of embodiments below.

### BRIEF DESCRIPTION OF THE DRAWINGS

The present invention can be appreciated by the description which follows in conjunction with the following figures, wherein:

FIG. 1 is a diagram for illustrating a configuration example of a computer system of a first embodiment of this invention;

FIG. 2A is a diagram for illustrating an example of a hardware configuration of a server in the first embodiment;

FIG. 2B is a diagram for illustrating an example of a hardware configuration of a management server in the first embodiment

FIG. 3 is a table for showing an example of a data structure of service configuration management information in the first embodiment;

FIG. 4 is a table for showing an example of a data structure of request path management information in the first embodiment

FIG. 5 is a table for showing an example of a data structure of request load feature information in the first embodiment

FIG. 6 is a table for showing an example of a data structure of service load feature information in the first embodiment;

FIG. 7 is a table for showing an example of a data structure of threshold value management information in the first embodiment;

FIG. 8 is a table for showing an example of a data structure of processing node performance information in the first embodiment;

FIG. 9 is a table for showing an example of a data structure of server performance information in the first embodiment;

FIG. 10 is a table for showing an example of a data structure of detection request information in the first embodiment;

FIG. 11 is a table for showing an example of a data structure of service execution information in the first embodiment;

FIG. 12 is a flowchart for illustrating an outline of processing to be executed by the management server in the first embodiment;

FIG. 13 is a table for showing an example of a data structure of a target request list generated by the management server in the first embodiment;

FIG. 14 is a flowchart for illustrating an example of schedule generation processing to be executed by a load prediction unit in the first embodiment;

FIG. 15 is a flowchart for illustrating an example of load prediction processing to be executed by the load prediction unit in the first embodiment;

FIG. 16 is a table for showing an example of a data structure of predicted value information generated by the load prediction unit in the first embodiment;

FIG. 17 is a flowchart for illustrating an example of maximum usage calculation processing to be executed by the load prediction unit in the first embodiment;

FIG. 18 is a flowchart for illustrating an example of handling determination processing to be executed by the load prediction unit in the first embodiment;

FIG. 19 is a flowchart for illustrating an example of scale-out schedule generation processing to be executed by the load prediction unit in the first embodiment;

FIG. 20 is a table for showing an example of a data structure of scale-out schedule information 2000 generated by the load prediction unit in the first embodiment.

FIG. 21 is a flowchart for illustrating an example of scale-in schedule generation processing to be executed by the load prediction unit in the first embodiment;

FIG. 22 is a table for showing an example of a data structure of scale-in schedule information generated by the load prediction unit in the first embodiment;

FIG. 23 is a flowchart for illustrating an example of resource allocation change processing to be executed by an allocation change unit in the first embodiment;

FIG. 24 is a flowchart for illustrating an example of scale-out to be executed by the allocation change unit in the first embodiment;

FIG. 25 is a flowchart for illustrating an example of scale-in to be executed by the allocation change unit in the first embodiment;

FIG. 26 is a flowchart for illustrating an example of update processing for the request path management information to be executed by a management server controller in the first embodiment;

FIG. 27 is a table for showing an example of a data structure of a request relation map generated by the management server controller in the first embodiment;

FIG. 28 is a flowchart for illustrating an example of update processing for the service load feature information to be executed by the management server controller in the first embodiment;

FIG. 29 is a table for showing an example of a data structure of load analysis information generated by the management server controller in the first embodiment.

### DETAILED DESCRIPTION OF THE PREFERRED EMBODIMENTS

Now, a description is given of an embodiment of this invention referring to the drawings. It should be noted that this invention is not to be construed by limiting the invention to the content described in the following embodiment. A person skilled in the art would easily recognize that a specific configuration described in the following embodiment may be changed within the scope of the concept and the gist of this invention.

In a configuration of this invention described below, the same or similar components or functions are assigned with the same reference numerals, and a redundant description thereof is omitted here.

Notations of, for example, “first”, “second”, and “third” herein are assigned to distinguish between components, and do not necessarily limit the number or order of those components.

The position, size, shape, range, and others of each component illustrated in, for example, the drawings may not represent the actual position, size, shape, range, and other metrics in order to facilitate understanding of this invention. Thus, this invention is not limited to the position, size, shape, range, and others described in, for example, the drawings.

### First Embodiment

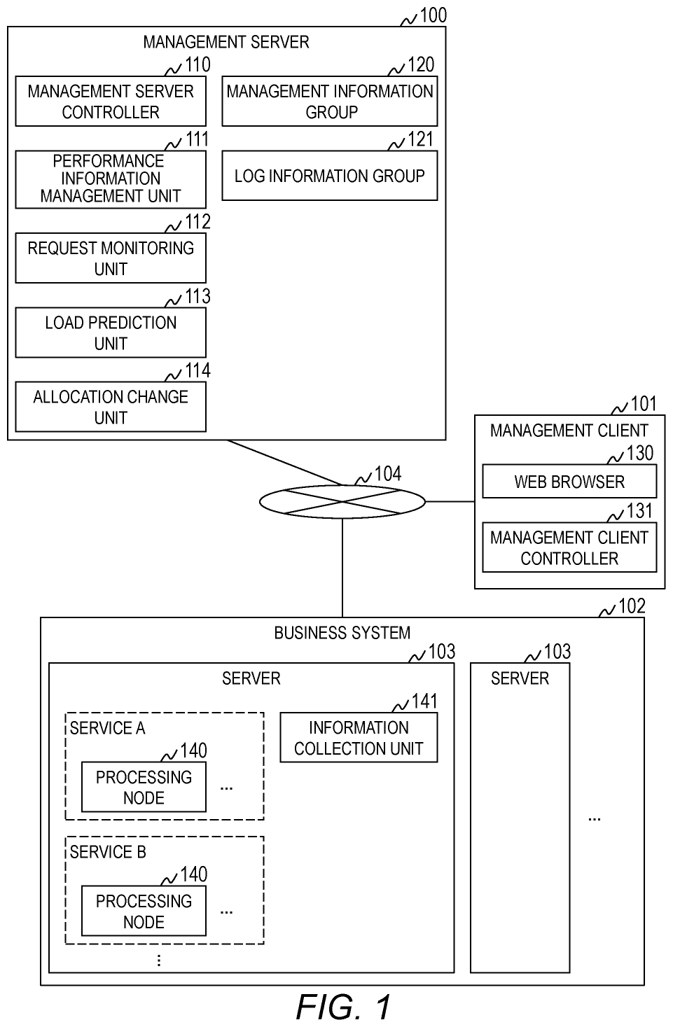

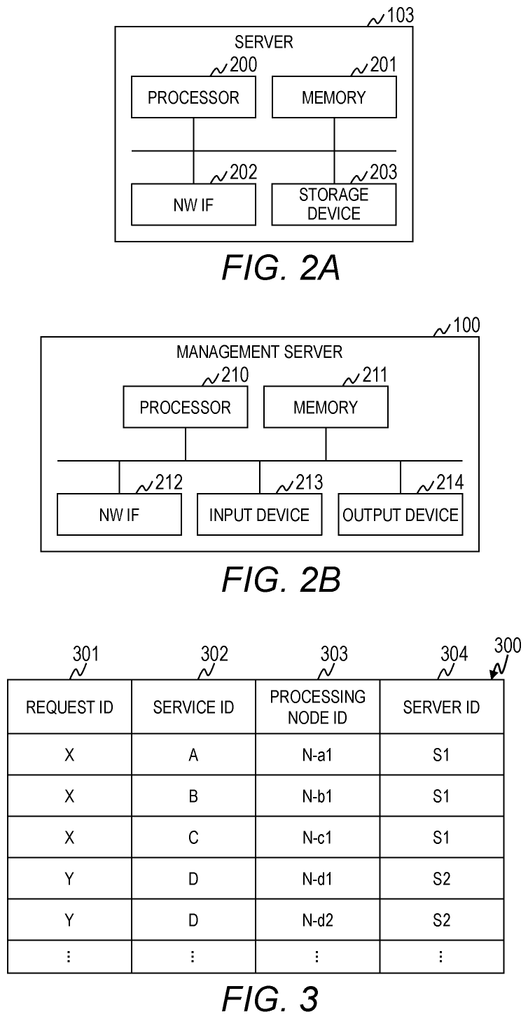

FIG. 1 is a diagram for illustrating a configuration example of a computer system of a first embodiment of this invention. FIG. 2A is a diagram for illustrating an example of a hardware configuration of a server 103 in the first embodiment. FIG. 2B is a diagram for illustrating an example of a hardware configuration of a management server 100 in the first embodiment.

The computer system includes a management server 100, a management client 101, and a business system 102. The management server 100, the management client 101, and the business system 102 are coupled to each other via a network 104. The network 104 is a local area network (LAN), a wide area network (WAN), or the like, and the coupling method may be wired or wireless.

The business system 102 is a platform configured to provide resources for implementing a service group providing a given function corresponding to a request. The business system 102 includes a plurality of servers 103. The business system 102 may also include apparatus (not shown) such as a storage system and a network switch.

Each server 103 is a computer configured to provide resources for implementing a processing node 140 configured to execute a service. The processing node 140 is, for example, a container and a virtual machine. There are one or more processing nodes 140 for each service. There may also be a processing node 140 configured to execute the same service in a plurality of servers 103.

Each server 103 includes a processor 200, a memory 201, a network interface 202, and a storage device 203. Each piece of hardware is coupled to each other via a bus.

The processor 200 is configured to execute a program stored in the memory 201. The processor 200 operates as a module configured to implement a specific function by executing processing in accordance with the program. In the following description, a sentence describing processing with a module as the subject of the sentence means that a program for implementing the module is executed by the processor 200.

The memory 201 stores a program to be executed by the processor 200 and information to be used by the program. The memory 201 includes a work area to be temporarily used by the program.

The memory 201 in the first embodiment stores a program for implementing an information collection unit 141. The information collection unit 141 is configured to collect various types of information, such as information on performance of the servers 103 and the processing nodes 140, and a processing state of the processing nodes 140. The memory 201 also stores programs for implementing, for example, an operating system (OS) and a virtualization unit configured to manage the processing nodes 140, but description thereof is omitted here.

The storage device 203 is a storage device such as a hard disk drive (HDD) and a solid state drive (SSD), and permanently stores data.

The programs and information stored in the memory 201 may be stored in the storage device 203. In this case, the processor 200 reads out the program and information from the storage device 203 and loads the program and information onto the memory 201.

The network interface 202 is an interface configured to communicate to and from an external apparatus.

The management server 100 is a computer configured to manage the business system 102. The functions of the management server 100 may be implemented by using a plurality of computers.

The management server 100 includes a processor 210, a memory 211, a network interface 212, an input device 213, and an output device 214. Each piece of hardware is coupled to each other via a bus. The management server 100 may also include a storage device.

The processor 210, the memory 211, and the network interface 212 are the same as the processor 200, the memory 201, and the network interface 202. The input device 213 is a device configured to input data, and is a keyboard, a mouse, a touch panel, and the like. The output device 214 is a device configured to output data, and is a display, a printer, and the like.

The memory 211 stores programs for implementing a management server controller 110, a performance information management unit 111, a request monitoring unit 112, a load prediction unit 113, and an allocation change unit 114. The memory 211 also stores a management information group 120 and a log information group 121.

The management information group 120 is various types of management information required for control described later. The log information group 121 is information on various types of logs obtained from the business system 102.

The management server controller 110 is configured to control the entire management server 100. The performance information management unit 111 is configured to manage information on the performance of the servers 103 and the processing nodes 140.

The request monitoring unit 112 is configured to monitor reception of a request triggering execution of a service group implementing a given function to be provided by using the business system 102.

The load prediction unit 113 is configured to predict a load of the service group to be executed based on the reception of a request serving as the starting point of continuous calling of a request, and generate a schedule for changing a resource allocation amount for a given service. Herein, the request serving as a starting point of continuously calling of a request is referred to as “starting point request,” and the service to be executed based on the reception of a starting point request is referred to as “related service.”

The allocation change unit 114 is configured to change the resource allocation amount for the given service based on the schedule.

Regarding each module included in the management server 100, a plurality of modules may be integrated as one module, or one module may be divided into a plurality of modules for each function. For example, the management server controller 110, the performance information management unit 111, the request monitoring unit 112, and the load prediction unit 113 may be integrated as a controller.

The management client 101 is a terminal configured to operate and manage a system (microservice) implementing a function formed of a plurality of services by using the business system 102. The hardware configuration of the management client 101 is the same as that of the management server 100, and therefore description thereof is omitted here.

Programs for implementing a web browser 130 and a management client controller 131 are stored in a memory of the management client 101.

Next, the information included in the management information group 120 is described with reference to FIG. 3 to FIG. 7.

FIG. 3 is a table for showing an example of a data structure of service configuration management information 300 in the first embodiment.

The service configuration management information 300 is information for managing the configuration of the service for providing the function corresponding to one request. The service configuration management information 300 stores an entry including a request ID 301, a service ID 302, a processing node ID 303, and a server ID 304. There is one entry for each processing node 140.

The request ID 301 is a field for storing identification information on the request. The service ID 302 is a field for storing identification information on the service providing the function corresponding to the request.

The processing node ID 303 is a field for storing identification information on the processing node 140 executing the service. The server ID 304 is a field for storing identification information on the server 103 providing a resource for implementing the processing node 140.

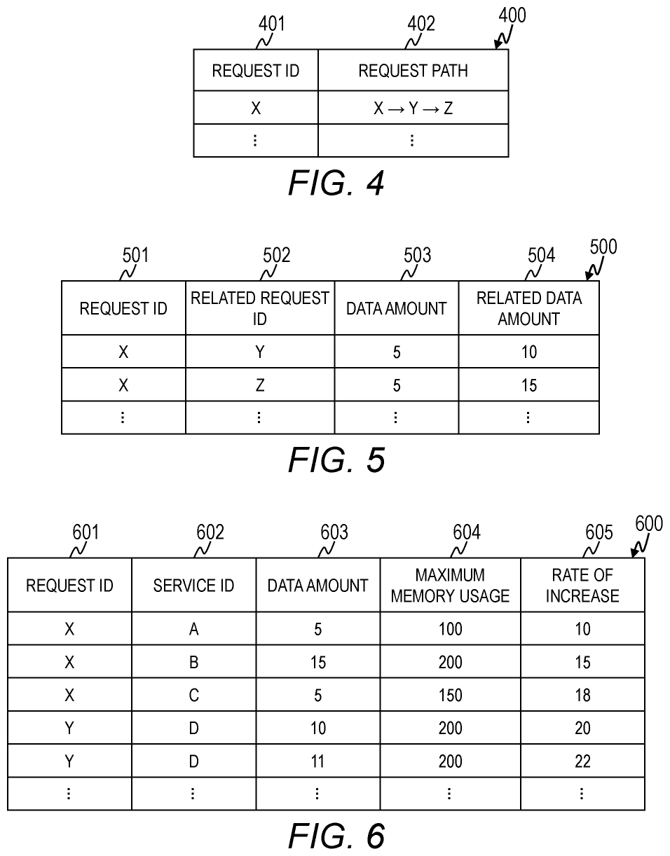

FIG. 4 is a table for showing an example of a data structure of request path management information 400 in the first embodiment.

The request path management information 400 is information for managing a request call relationship. The request path management information 400 stores an entry including a request ID 401 and a request path 402. There is one entry for each path.

The request ID 401 is a field for storing identification information on the starting point request. The request path 402 is a field for storing information indicating an order (path) of the requests to be called after the starting point request.

Herein, a request to be called after the starting point request is referred to as “related request.”

FIG. 5 is a table for showing an example of a data structure of request load feature information 500 in the first embodiment.

The request load feature information 500 is information used in a case where a reception count of a related request is calculated based on a reception count of the starting point request. The request load feature information 500 stores an entry including a request ID 501, a related request ID 502, a data amount 503, and a related data amount 504. There is one entry for each combination of the starting point request, the related request, and the reception count of the starting point request.

The request ID 501 is a field for storing identification information on the starting point request. The related request ID 502 is a field for storing identification information on the related request.

The data amount 503 is a field for storing the reception count of the starting point request. The related data amount 504 is a field for storing the reception count of a related request with respect to the reception count of the starting point request.

FIG. 6 is a table for showing an example of a data structure of service load feature information 600 in the first embodiment.

The service load feature information 600 is information used in a case where the load of the service is calculated. The service load feature information 600 stores an entry including a request ID 601, a service ID 602, a data amount 603, a maximum memory usage 604, and a rate of increase 605. There is one entry for each combination of the starting point request, the service, and the reception count of the starting point request.

The request ID 601 is a field for storing identification information on the request. The service ID 602 is a field for storing identification information on the service providing the function corresponding to the request.

The data amount 603 is a field for storing the reception count of the request. The maximum memory usage 604 is a field for storing a usage of the memory 201 used by executing the service. In the first embodiment, an entry including only the maximum memory usage 604 is described for the sake of simplicity, but the entry also may include a field for storing the maximum usage of a metric other than the memory usage.

The rate of increase 605 is a field for storing a rate of increase indicating the amount of increase in the value of the metric per unit time due to the increase in the load of the service.

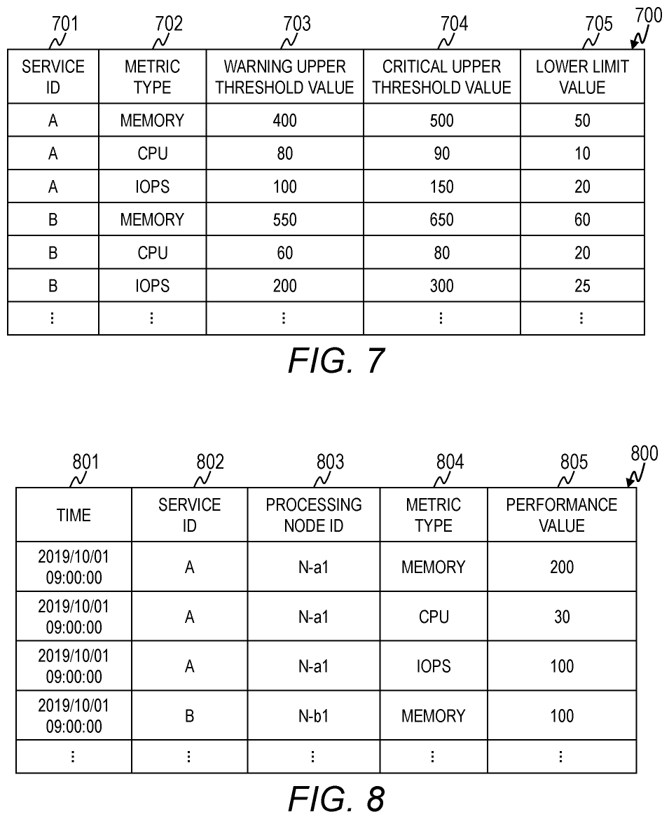

FIG. 7 is a table for showing an example of a data structure of threshold value management information 700 in the first embodiment.

The threshold value management information 700 is information for managing various types of threshold values to be used in the determination processing. The threshold value management information 700 stores an entry including a service ID 701, a metric type 702, a warning upper limit threshold value 703, a critical upper limit threshold value 704, and a lower limit value 705. There is one entry for each combination of the service and the metric.

The service ID 701 is a field for storing identification information on the service. The metric type 702 is a field for storing identification information on the metric.

The warning upper limit threshold value 703 is a field for storing the value of a metric defining an end target time point of scale-out. In the first embodiment, the scheduling is performed such that scale-out is completed before the value of the metric becomes larger than the warning upper limit threshold value 703.

The critical upper limit threshold value 704 is a field for storing a threshold value for determining whether or not to execute scale-out. The lower limit value 705 is a field for storing a threshold value for determining whether or not to execute scale-in.

Next, the information included in the log information group 121 is described with reference to FIG. 8 to FIG. 11.

FIG. 8 is a table for showing an example of a data structure of processing node performance information 800 in the first embodiment.

The processing node performance information 800 is information for managing a history of the performance values of the processing nodes 140 exhibited when the service is executed. The processing node performance information 800 stores an entry including a time 801, a service ID 802, a processing node ID 803, a metric type 804, and a performance value 805. There is one entry for each combination of the time, the service, the processing node 140, and the metric.

The time 801 is a field for storing the time at which the performance value was measured. The service ID 802 is a field for storing identification information on the service executed by the processing node 140. The processing node ID 803 is a field for storing identification information on the processing node 140.

The metric type 804 is a field for storing identification information on the metric. The performance value 805 is a field for storing a measured performance value of the metric of the processing node 140.

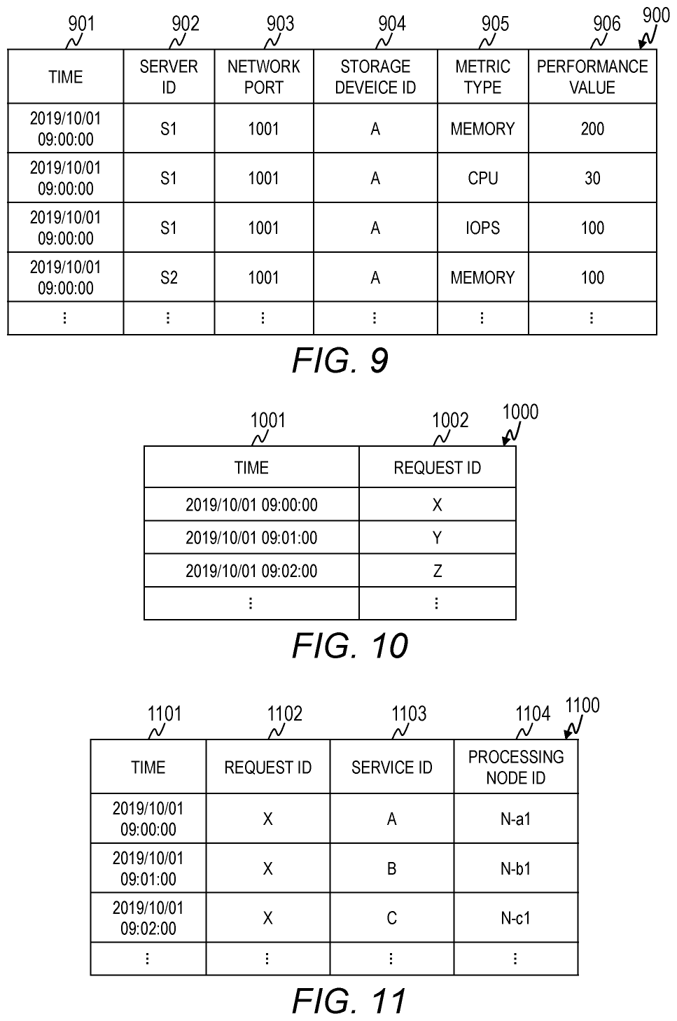

FIG. 9 is a table for showing an example of a data structure of server performance information 900 in the first embodiment.

The server performance information 900 is information for managing a history of the performance values of the servers 103. The server performance information 900 stores an entry including a time 901, a server ID 902, a network port 903, a storage device ID 904, a metric type 905, and a performance value 906. There is one entry for each combination of the time, the server 103, and the metric performance value.

The time 901 is a field for storing the time at which the performance value was measured. The server ID 902 is a field for storing identification information on the server 103. The network port 903 is a field for storing a number of the port used for communication. The storage device ID 904 is a field for storing identification information on the storage device used by the server 103.

The metric type 905 is a field for storing identification information on the metric. The performance value 906 is a field for storing a measurement value of the metric of the server 103.

FIG. 10 is a table for showing an example of a data structure of detection request information 1000 in the first embodiment.

The detection request information 1000 is information for managing a history of each received request. The detection request information 1000 stores an entry including a time 1001 and a request ID 1002. There is one entry for each detection result.

The time 1001 is a field for storing the time at which reception of the request was detected. The request ID 1002 is a field for storing identification information on the detected request.

FIG. 11 is a table for showing an example of a data structure of service execution information 1100 in the first embodiment.

The service execution information 1100 is information for managing a history of the service executed in a case where a request is received. The service execution information 1100 stores an entry including a time 1101, a request ID 1102, a service ID 1103, and a processing node ID 1104. There is one entry for each service execution result.

The time 1101 is a field for storing the time at which execution of the service was detected. The request ID 1102 is a field for storing identification information on the request. The service ID 1103 is a field for storing identification information on the service. The processing node ID 1104 is a field for storing identification information on the processing node 140 that executed the service.

The processing node performance information 800 and the server performance information 900 are generated by the performance information management unit 111 based on information transmitted from the information collection unit 141. The detection request information 1000 and the service execution information 1100 are generated by the request monitoring unit 112 based on information transmitted from the information collection unit 141.

Next, processing to be executed by the management server 100 is described.

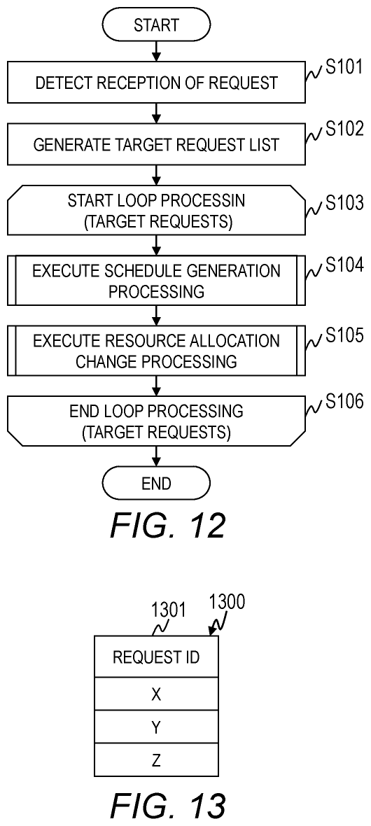

FIG. 12 is a flowchart for illustrating an outline of processing to be executed by the management server 100 in the first embodiment. FIG. 13 is a table for showing an example of a data structure of a target request list 1300 generated by the management server 100 in the first embodiment.

In a case where the request monitoring unit 112 detects the reception of a request based on information received from the information collection unit 141 (Step S101), the request monitoring unit 112 notifies the management server controller 110 of the reception of the request.

In a case where the request monitoring unit 112 detects that the first service of a service group providing a certain function has been executed, the request monitoring unit 112 adds to the detection request information 1000 an entry of a request calling the function. Further, in a case where the request monitoring unit 112 detects that a service has been executed, the request monitoring unit 112 adds an entry of the service to the service execution information 1100.

Next, the management server controller 110 refers to the request path management information 400, and generates the target request list 1300 (Step S102). Specifically, the following processing is executed.

The management server controller 110 retrieves entry in which the identification information on the request detected in the request ID 401 is stored. The management server controller 110 identifies related requests based on the request path 402 of the retrieved entry.

The management server controller 110 registers the detected request (starting point request) and the related requests in the target request list 1300 as target requests. The entries are registered in the order in which the requests are to be called. The target request list 1300 stores the entries including the request ID 1301.

In a case where there is no relevant entry in the request path management information 400, the management server controller 110 ends the processing without executing the subsequent processing from Step S103. The reason for this is that the received request is a related request, and a schedule has already been generated. There has been provided above description of the processing of Step S102.

Next, the management server controller 110 starts loop processing for the target requests (Step S103).

Specifically, the management server controller 110 selects one target request from the target request list 1300.

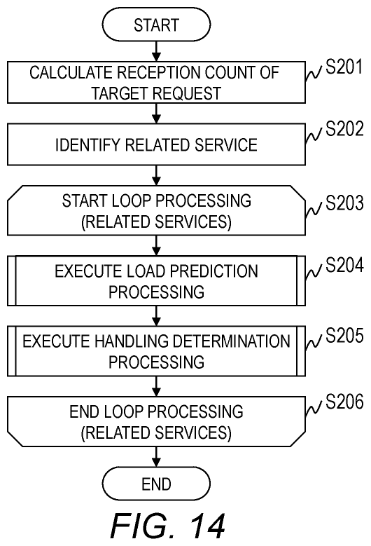

Next, the management server controller 110 instructs the load prediction unit 113 to execute schedule generation processing (Step S104). The details of the schedule generation processing are described with reference to FIG. 14.

After completion of the schedule generation processing has been detected, the management server controller 110 instructs the allocation change unit 114 to execute the resource allocation change processing (Step S105). The details of the resource allocation change processing are described with reference to FIG. 23.

After completion of the resource allocation change processing has been detected, the management server controller 110 determines whether or not the processing is complete for all of the target requests in the target request list 1300 (Step S106).

In a case where the processing is not complete for all of the target requests in the target request list 1300, the management server controller 110 returns to Step S103 and executes the same processing.

In a case where the processing is complete for all of the target requests in the target request list 1300, the management server controller 110 ends the processing.

FIG. 14 is a flowchart for illustrating an example of the schedule generation processing to be executed by the load prediction unit 113 in the first embodiment.

First, the load prediction unit 113 calculates the reception count of the target request (Step S201). Specifically, the following processing is executed.

The load prediction unit 113 determines whether or not the target request is a starting point request.

In a case where the target request is a starting point request, the load prediction unit 113 calculates, based on the detection request information 1000, the reception count of the starting point request in a fixed period of time after detecting the starting point request.

In a case where the target request is a related request, the load prediction unit 113 refers to the request load feature information 500, and retrieves the entry in which the identification information on the starting point request is stored in the request ID 501 and the identification information on the target request is stored in the related request ID 502. The load prediction unit 113 calculates the reception count of the target request based on the reception count of the starting point request and the data amount 503 of the retrieved entry. For example, the load prediction unit 113 multiplies the related data amount 504 by a value obtained by dividing the reception count of the starting point request by the data amount 503. There has been provided above description of the processing of Step S201.

Next, the load prediction unit 113 refers to the service configuration management information 300, and identifies the service (related service) providing the function corresponding to the target request (Step S202).

Specifically, the load prediction unit 113 retrieves the entries in which the identification information on the target request is stored in the request ID 301. The load prediction unit 113 generates a related service list by using the retrieved entries. The service providing the function corresponding to the target request is a service to be executed in a case where a starting point request is received, that is, is a related service.

Next, the load prediction unit 113 starts loop processing for the related services (Step S203).

Specifically, the load prediction unit 113 selects one related service from the related service list.

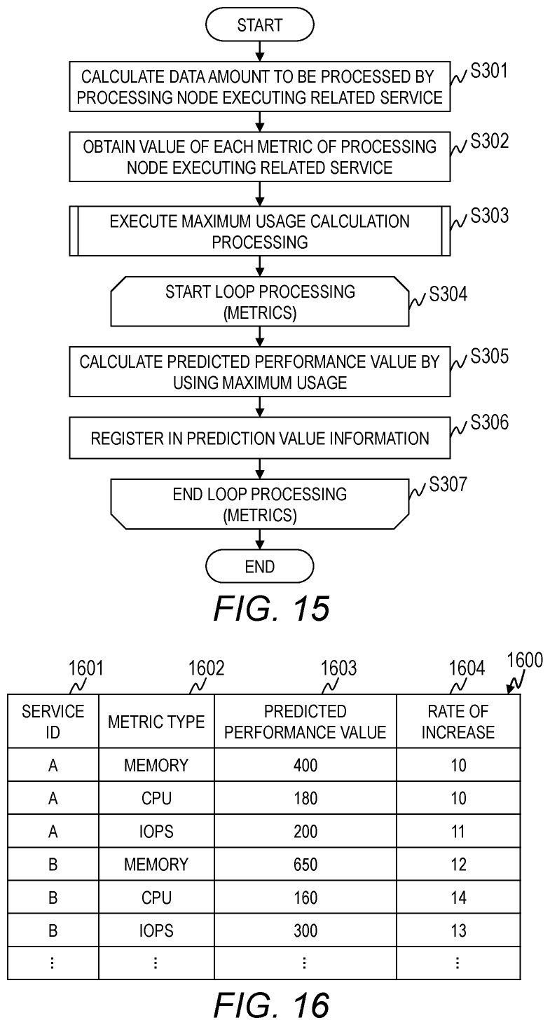

Next, the load prediction unit 113 executes load prediction processing for predicting the load of the related service (Step S204). The details of the load prediction processing are described with reference to FIG. 15.

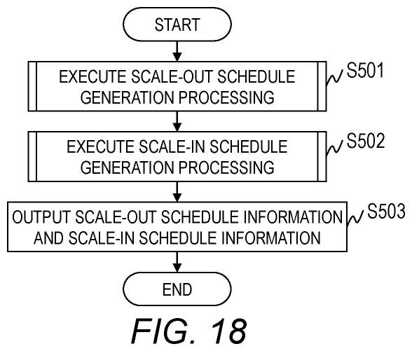

Next, the load prediction unit 113 executes handling determination processing by using the result of the load prediction processing (Step S205). The details of the handling determination processing are described with reference to FIG. 18.

Next, the load prediction unit 113 determines whether or not the processing is complete for all of the related services in the related service list (Step S206).

In a case where the processing is not complete for all of the related services in the related service list, the load prediction unit 113 returns to Step S203 and executes the same processing.

In a case where the processing is complete for all of the related services in the related service list, the load prediction unit 113 notifies the management server controller 110 of the completion of the schedule generation processing, and then ends the schedule generation processing.

FIG. 15 is a flowchart for illustrating an example of the load prediction processing to be executed by the load prediction unit 113 in the first embodiment. FIG. 16 is a table for showing an example of a data structure of predicted value information 1600 generated by the load prediction unit 113 in the first embodiment.

The load prediction unit 113 calculates, based on the reception count of the target request, the data amount to be processed by the processing node 140 executing the related service selected in Step S202 (Step S301).

Specifically, the load prediction unit 113 refers to the service configuration management information 300, and retrieves entries in which the identification information on the target request is stored in the request ID 301 and the identification information on the related service is stored in the service ID 302. Specifically, the entries of the processing nodes 140 executing the related service are retrieved. The load prediction unit 113 calculates the data amount to be processed by one processing node 140 by dividing the reception count of the target request by the number of entries (number of processing nodes 140).

In the first embodiment, it is assumed that processing nodes 140 executing the same service execute distributed processing such that the loads are uniform.

Next, the load prediction unit 113 refers to the processing node performance information 800, and obtains the current performance value of each metric of the processing node 140 executing the related service (Step S302). At this time, the load prediction unit 113 generates a metric list. In a case where there are a plurality of processing nodes 140 executing the same related service, the highest performance value among the performance values of the metrics of each processing node 140 is obtained.

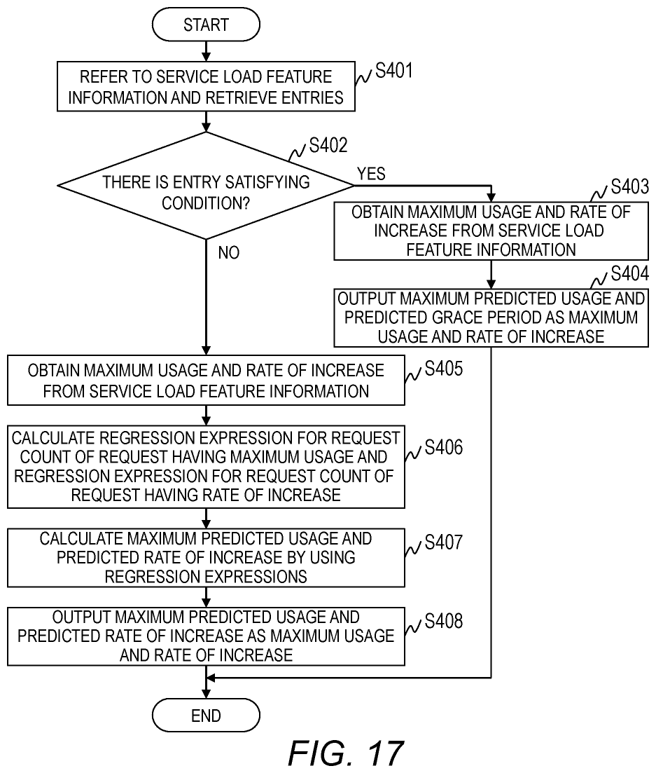

Next, the load prediction unit 113 executes maximum usage calculation processing in order to calculate a maximum predicted value of the usage of each metric (Step S303). The details of the maximum usage calculation processing are described with reference to FIG. 17. In the maximum usage calculation processing, the maximum usage and a rate of increase of each metric are calculated.

Next, the load prediction unit 113 starts loop processing for the metrics (Step S304).

Specifically, the load prediction unit 113 selects one metric from the metric list.

Next, the load prediction unit 113 calculates the predicted performance value of the selected metric by using the maximum usage of the selected metric and the current performance value of the selected metric (Step S305).

Specifically, the load prediction unit 113 calculates a sum of the maximum usage of the selected metric and the current performance value of the selected metric as the predicted performance value of the selected metric. Next, the load prediction unit 113 registers the results of the series of processing procedures in the predicted value information 1600 (Step S306).

The predicted value information 1600 stores an entry including a service ID 1601, a metric type 1602, a predicted performance value 1603, and a rate of increase 1604. There is one entry for each combination of the service and the metric.

The load prediction unit 113 adds the entry to the predicted value information 1600, and sets the identification information on the selected related service and the type of the selected metric in the service ID 1601 and the metric type 1602 of the added entry. Further, the load prediction unit 113 stores the calculated predicted performance value in the predicted performance value 1603 of the added entry, and stores the calculated rate of increase in the rate of increase 1604.

Next, the load prediction unit 113 determines whether or not the processing is complete for all of the metrics in the metric list (Step S307).

In a case where the processing is not complete for all of the metrics in the metric list, the load prediction unit 113 returns to Step S304 and executes the same processing.

In a case where the processing is complete for all of the metrics in the metric list, the load prediction unit 113 ends the load prediction processing.

FIG. 17 is a flowchart for illustrating an example of the maximum usage calculation processing to be executed by the load prediction unit 113 in the first embodiment.

The load prediction unit 113 refers to the service load feature information 600, and retrieves entry matching the combination of the target request, the related service, and the reception count of the target request (Step S401).

The load prediction unit 113 determines, based on the retrieval result, whether or not there is an entry satisfying the above-mentioned condition (Step S402).

In a case where there is an entry satisfying the above-mentioned condition, the load prediction unit 113 obtains the values from the maximum memory usage 604 and the rate of increase 605 of the entry (Step S403).

Next, the load prediction unit 113 outputs the values obtained from the service load feature information 600 as the maximum usage and the rate of increase (Step S404). Then, the load prediction unit 113 ends the maximum usage calculation processing.

In Step S402, in a case where there is no entry satisfying the above-mentioned condition, the load prediction unit 113 refers to the service load feature information 600, retrieves entries matching the combination of the target request and the related service, and obtains the values of the data amount 603, the maximum memory usage 604, and the rate of increase 605 of the retrieved entries (Step S405).

Next, the load prediction unit 113 uses the obtained values to calculate a regression expression for the reception count (request count) of the request having the maximum usage and a regression expression for the reception count (request count) of the request having a rate of increase (Step S406). Specifically, a model for calculating the maximum usage and the rate of increase is generated from the reception count of the request.

Next, the load prediction unit 113 calculates a maximum predicted usage and a predicted rate of increase by inputting the data amount to be processed by each processing node 140 executing the related service into each regression expression (Step S407).

Next, the load prediction unit 113 outputs the maximum predicted usage and the predicted rate of increase as the maximum usage and the rate of increase (Step S408). Then, the load prediction unit 113 ends the maximum usage calculation processing.

FIG. 18 is a flowchart for illustrating an example of the handling determination processing to be executed by the load prediction unit 113 in the first embodiment.

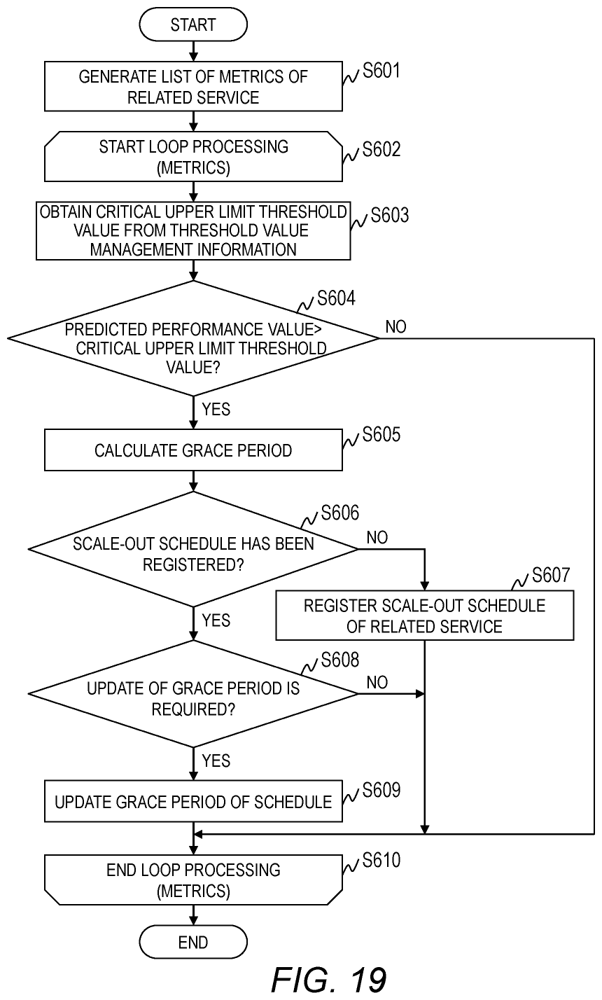

The load prediction unit 113 executes scale-out schedule generation processing and scale-in schedule generation processing by using the result of the load prediction processing (Step S501 and Step S502). The details of the scale-out schedule generation processing are described with reference to FIG. 19, and the details of the scale-in schedule generation processing are described with reference to FIG. 21.

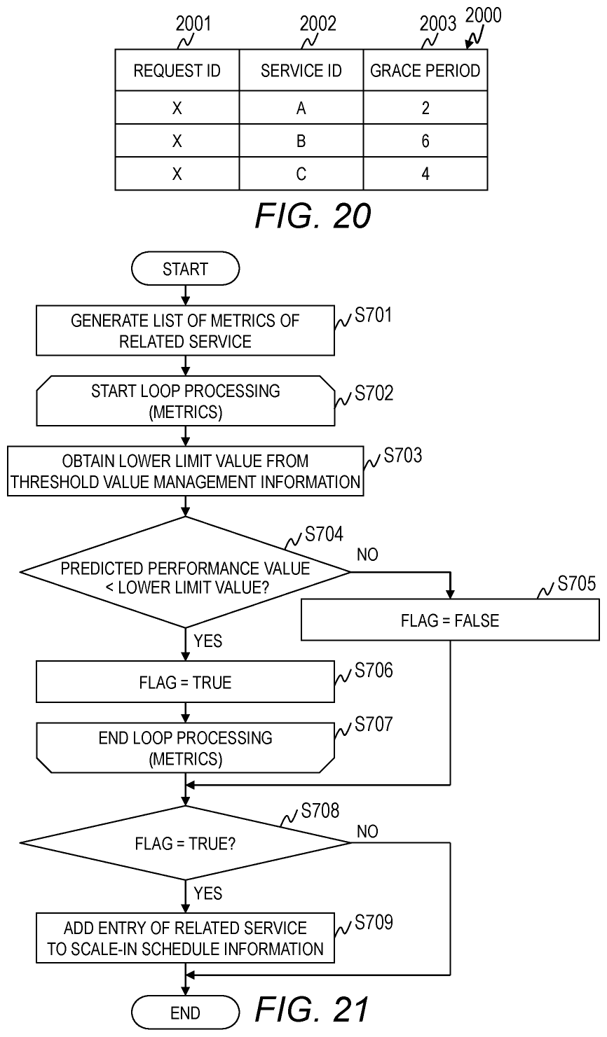

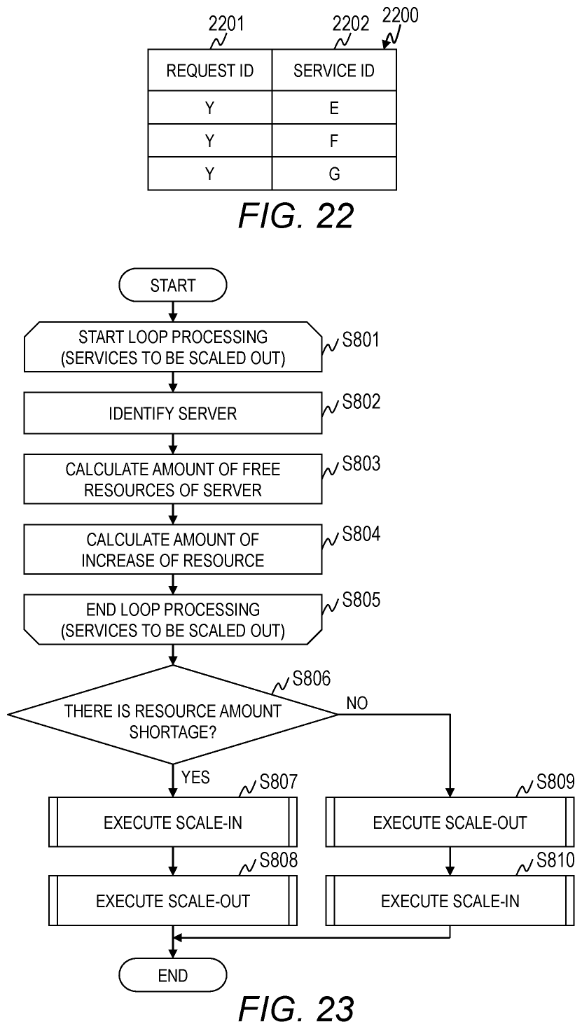

Next, the load prediction unit 113 outputs scale-out schedule information 2000 (shown in FIG. 20) and scale-in schedule information 2200 (shown in FIG. 22) to a work area (Step S503). Then, the load prediction unit 113 ends the handling determination processing.

FIG. 19 is a flowchart for illustrating an example of the scale-out schedule generation processing to be executed by the load prediction unit 113 in the first embodiment. FIG. 20 is a table for showing an example of a data structure of the scale-out schedule information 2000 generated by the load prediction unit 113 in the first embodiment.

The load prediction unit 113 refers to the processing node performance information 800, and generates a list of the metrics of the processing nodes 140 executing the related service (Step S601).

Next, the load prediction unit 113 starts loop processing for the metrics (Step S602).

Specifically, the load prediction unit 113 selects one metric from the metric list.

Next, the load prediction unit 113 obtains a critical upper limit threshold value and a warning upper limit threshold value from the threshold value management information 700 (Step S603).

Specifically, the load prediction unit 113 retrieves entry in which the identification information on the related service is stored in the service ID 701 and the identification information on the selected metric is stored in the metric type 702, and obtains the values of the warning upper limit threshold value 703 and the critical upper limit threshold value 704 of the retrieved entry. Further, the load prediction unit 113 obtains the predicted performance value and the rate of increase of the metric of the related service from the predicted value information 1600.

Next, the load prediction unit 113 determines whether or not the predicted performance value of the metric calculated by the load prediction processing is larger than the critical upper limit threshold value (Step S604).

In a case where the predicted performance value of the metric is equal to or smaller than the critical upper limit threshold value, the load prediction unit 113 advances to Step S610.

In a case where the predicted performance value of the metric is larger than the critical upper limit threshold value, the load prediction unit 113 calculates a grace period for scale-out of the related service (Step S605). Specifically, the load prediction unit 113 subtracts the predicted performance value from the warning upper limit threshold value. The load prediction unit 113 calculates the grace period by dividing the calculated value by the rate of increase.

Next, the load prediction unit 113 determines whether or not the scale-out schedule of the related service is registered in the scale-out schedule information 2000 (Step S606).

The scale-out schedule information 2000 stores an entry including a request ID 2001, a service ID 2002, and a grace period 2003. There is one entry for each service to be scaled out. Each entry may also be referred to as “scale-out schedule.”

In Step S606, the load prediction unit 113 determines whether or not an entry exists in which the identification information on the target request is stored in the request ID 2001 and the identification information on the related service is stored in the service ID 2002.

In a case where the scale-out schedule of the related service is not registered in the scale-out schedule information 2000, the load prediction unit 113 registers the scale-out schedule of the related service in the scale-out schedule information 2000 (Step S607). Then, the load prediction unit 113 advances to Step S610.

Specifically, the load prediction unit 113 adds an entry to the scale-out schedule information 2000, sets the identification information on the target request in the request ID 2001 of the added entry, sets the identification information on the related service in the service ID 2002, and sets the calculated grace period in the grace period 2003.

In a case where the scale-out schedule of the related service is registered in the scale-out schedule information 2000, the load prediction unit 113 determines whether or not an update of the grace period of the registered scale-out schedule is required (Step S608).

Specifically, the load prediction unit 113 determines whether or not the grace period 2003 of the scale-out schedule is larger than the calculated grace period. In a case where the grace period 2003 is larger than the calculated grace period, the load prediction unit 113 determines that the grace period of the registered scale-out schedule is required to be updated.

In a case where the grace period of the registered scale-out schedule is not required to be updated, the load prediction unit 113 advances to Step S610.

In a case where the grace period of the registered scale-out schedule is required to be updated, the load prediction unit 113 sets the calculated grace period in the grace period 2003 of the registered schedule (Step S609). Then, the load prediction unit 113 advances to Step S610.

In Step S610, the load prediction unit 113 determines whether or not the processing is complete for all of the metrics in the metric list (Step S610).

In a case where the processing is not complete for all of the metrics in the metric list, the load prediction unit 113 returns to Step S602 and executes the same processing.

In a case where the processing is complete for all of the metrics in the metric list, the load prediction unit 113 ends the scale-out schedule generation processing.

In the scale-out schedule generation processing, the load prediction unit 113 determines that a related service including at least one metric having a predicted performance value larger than the critical upper limit threshold value is to be scaled out.

FIG. 21 is a flowchart for illustrating an example of the scale-in schedule generation processing to be executed by the load prediction unit 113 in the first embodiment. FIG. 22 is a table for showing an example of a data structure of the scale-in schedule information 2200 generated by the load prediction unit 113 in the first embodiment.

The load prediction unit 113 refers to the processing node performance information 800, and generates a list of the metrics of the processing nodes 140 executing the related service (Step S701).

Next, the load prediction unit 113 starts loop processing for the metrics (Step S702).

Specifically, the load prediction unit 113 selects one metric from the metric list.

Next, the load prediction unit 113 obtains a lower limit value from the threshold value management information 700 (Step S703).

Specifically, the load prediction unit 113 retrieves entry in which the identification information on the related service is stored in the service ID 701 and the identification information on the selected metric is stored in the metric type 702, and obtains the value of the lower limit value 705 of the retrieved entry. Further, the load prediction unit 113 obtains the predicted performance value of the metric of the related service from the predicted value information 1600.

Next, the load prediction unit 113 determines whether or not the predicted performance value of the metric calculated by the load prediction processing is smaller than the lower limit value (Step S704).

In a case where the predicted performance value of the metric is equal to or larger than the lower limit value, the load prediction unit 113 sets “false” to a flag, ends the loop processing (Step S705), and advances to Step S708.

In a case where the predicted performance value of the metric is smaller than the lower limit value, the load prediction unit 113 sets “true” to the flag (Step S706).

Next, the load prediction unit 113 determines whether or not the processing is complete for all of the metrics in the metric list (Step S707).

In a case where the processing is not complete for all of the metrics in the metric list, the load prediction unit 113 returns to Step S702 and executes the same processing.

In a case where the processing is complete for all of the metrics in the metric list, the load prediction unit 113 advances to Step S708.

In Step S708, the load prediction unit 113 determines whether the flag is “true” (Step S708).

In a case where the flag is “false,” the load prediction unit 113 ends the scale-in schedule generation processing.

In a case where the flag is “true,” the load prediction unit 113 registers the scale-in schedule of the related service in the scale-in schedule information 2200 (Step S709). Then, the load prediction unit 113 ends the scale-in schedule generation processing.

In this case, the scale-in schedule information 2200 stores an entry including a request ID 2201 and a service ID 2202. There is one entry for each service to be scaled in. One entry may also be referred to as a “scale-in schedule.”

In the scale-in schedule generation processing, the load prediction unit 113 determines that a related service in which the predicted performance values for all of the metrics are smaller than the lower limit value are to be scaled in.

FIG. 23 is a flowchart for illustrating an example of the resource allocation change processing to be executed by the allocation change unit 114 in the first embodiment.

The allocation change unit 114 starts loop processing for the services to be scaled out (Step S801).

Specifically, the allocation change unit 114 selects one service (entry) from the scale-out schedule information 2000.

Next, the allocation change unit 114 identifies the server 103 operating the processing node 140 executing the selected service (Step S802).

Specifically, the allocation change unit 114 refers to the service configuration management information 300, and retrieves the entries having a service ID 302 matching the identification information on the selected service. The allocation change unit 114 obtains the value of the server ID 304 of each retrieved entry.

Next, the allocation change unit 114 calculates the amount of free resources of each identified server 103 (Step S803).

Specifically, the allocation change unit 114 refers to the server performance information 900, and retrieves the entries in which the server ID 902 matches the identification information on the identified servers 103. The allocation change unit 114 calculates the amount of free resources for each metric by using the performance value 906 of the retrieved entries.

Next, the allocation change unit 114 calculates a predicted value (amount of increase) of the resource amount due to scale-out (Step S804).

A known technology may be used to predict the resource amount by scale-out. For example, the following method can be considered.

The allocation change unit 114 refers to the processing node performance information 800, and retrieves entries in which the identification information on the selected service is stored in the service ID 802. The allocation change unit 114 calculates an average value of the performance values of each metric by using the retrieved entries. Further, the allocation change unit 114 calculates a value obtained by adding the above-mentioned average value to the current performance value of the server 103 as a predicted value of the resource amount of the server 103 after scale-out. This calculation method is an example, and this invention is not limited to thereto.

Next, the allocation change unit 114 determines whether or not the processing is complete for all of the services of the scale-out schedule information 2000 (Step S805).

In a case where the processing is not complete for all of the services of the scale-out schedule information 2000, the allocation change unit 114 returns to Step S801 and executes the same processing.

In a case where the processing is complete for all of the services of the scale-out schedule information 2000, the allocation change unit 114 determines, based on the amount of free resources and the increase amounts of the services to be scaled out, whether or not there is a service having a resource shortage (Step S806).

In a case where there is a service having a resource shortage, the allocation change unit 114 executes scale-in (Step S807) and then scale-out (Step S808). Then, the allocation change unit 114 ends the resource allocation change processing. In a case where there is a service having a resource shortage, scale-in is executed first in order to secure the required resource amount for scale-out.

In a case where there is no service having a resource shortage, the allocation change unit 114 executes scale-out (Step S809) and then scale-in (Step S810). Then, the allocation change unit 114 ends the resource allocation change processing. Scale-out is executed first in order to quickly respond to the reduction in the service load.

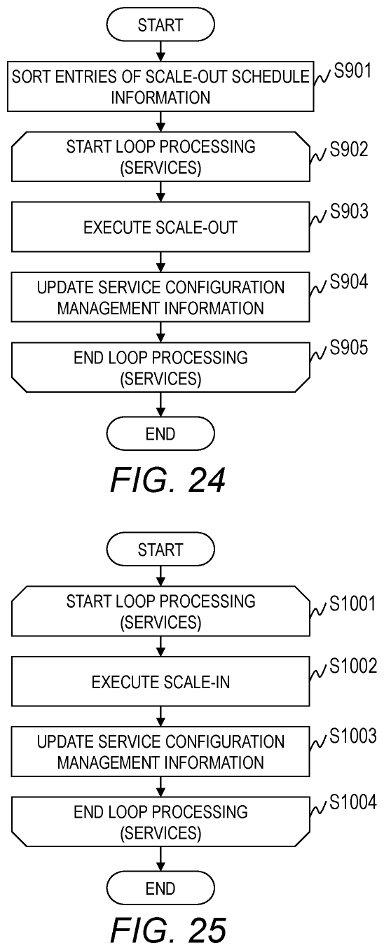

The scale-out in Step S808 and Step S809 is the same processing. The details of scale-out are described with reference to FIG. 24. The scale-in in Step S807 and Step S810 is the same processing. The details of scale-in are described with reference to FIG. 25.

FIG. 24 is a flowchart for illustrating an example of scale-out to be executed by the allocation change unit 114 in the first embodiment.

The allocation change unit 114 sorts the entries of the scale-out schedule information 2000 based on the length of the grace period (Step S901).

Specifically, the allocation change unit 114 sorts the entries in ascending order of the value of the grace period 2003.

Next, the allocation change unit 114 starts loop processing for the service to be scaled out (Step S902).

Specifically, the allocation change unit 114 selects one service (entry) from the scale-out schedule information 2000. The entries are selected in descending order from the top. The reason for this is to preferentially execute scale-out of a service in which the time until the metric value reaches the warning upper limit threshold value is short.

Next, the allocation change unit 114 executes scale-out of the selected service (Step S903).

In a case where the processing node 140 is a container, the allocation change unit 114 deploys an image of the container on the server 103 in which the processing node 140 corresponding to the service exists or another server 103. In a case where the processing node 140 is a virtual machine, the allocation change unit 114 instructs the server 103 in which the processing node 140 corresponding to the service exists or another server 103 to generate a virtual machine. The scale-out method is a known technology, and therefore a detailed description thereof is omitted here.

Next, the allocation change unit 114 updates the service configuration management information 300 (Step S904).

Specifically, the allocation change unit 114 adds an entry to the service configuration management information 300 and sets the values of the request ID 2001 and the service ID 2002 in the request ID 301 and the service ID 302 of the added entry. Further, the allocation change unit 114 sets the values in the processing node ID 303 and the server ID 304 of the added entry based on the result of scale-out.

Next, the allocation change unit 114 determines whether or not the processing is complete for all of the services to be scaled out (Step S905). Specifically, it is determined whether or not the processing of all of the entries of the scale-out schedule information 2000 is complete.

In a case where the processing is not complete for all of the services to be scaled out, the allocation change unit 114 returns to Step S902 and executes the same processing.

In a case where the processing is complete for all of the services to be scaled out, the allocation change unit 114 ends scale-out.

FIG. 25 is a flowchart for illustrating an example of scale-in to be executed by the allocation change unit 114 in the first embodiment.

The allocation change unit 114 starts loop processing of the service to be scaled in (Step S1001).

Specifically, the allocation change unit 114 selects one service (entry) from the scale-in schedule information 2200.

Next, the allocation change unit 114 executes scale-in of the selected service (Step S1002). The scale-in method is a known technology, and therefore a detailed description thereof is omitted here.

Next, the allocation change unit 114 updates the service configuration management information 300 (Step S1003).

Specifically, the allocation change unit 114 deletes the entry of the service configuration management information 300 based on the result of scale-in.

Next, the allocation change unit 114 determines whether or not the processing is complete for all of the services to be scaled in (Step S1004). Specifically, it is determined whether or not the processing of all of the entries of the scale-in schedule information 2200 is complete.

In a case where the processing is not complete for all of the services to be scaled in, the allocation change unit 114 returns to Step S1001 and executes the same processing.

In a case where the processing is complete for all of the services to be scaled in, the allocation change unit 114 ends scale-in.

Next, a method of updating the request path management information 400 and a method of updating the service load feature information 600 are described.

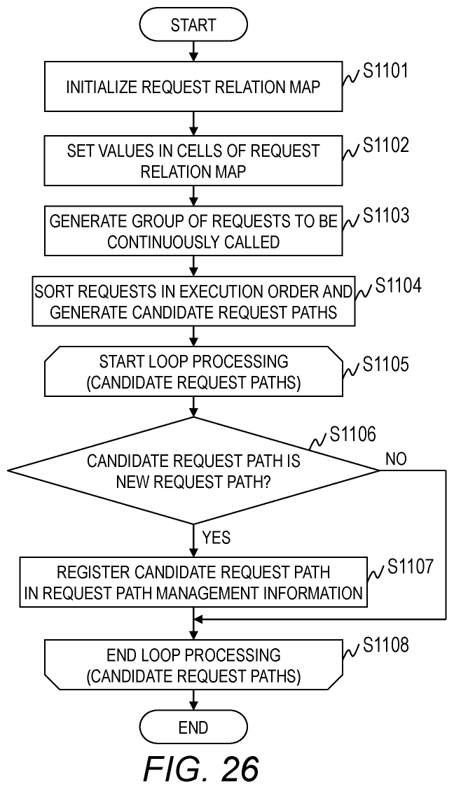

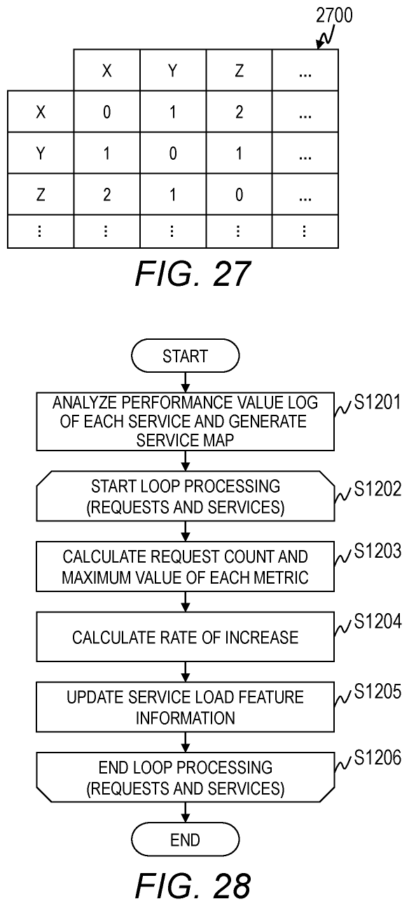

FIG. 26 is a flowchart for illustrating an example of update processing for the request path management information 400 to be executed by the management server controller 110 in the first embodiment. FIG. 27 is a table for showing an example of a data structure of a request relation map 2700 generated by the management server controller 110 in the first embodiment.

The management server controller 110 executes the following update processing periodically or in a case where an execution instruction is received.

First, the management server controller 110 initializes the request relation map 2700 (Step S1101).

Specifically, the management server controller 110 refers to the detection request information 1000, and generates a matrix-type request relation map 2700 in which the types of detected requests are row and column components. Each cell stores a difference (time) between the time of the request corresponding to the row and the time of the request corresponding to the column.

Next, the management server controller 110 refers to the detection request information 1000, and sets the values in the cells of the request relation map 2700 (Step S1102).

Next, the management server controller 110 generates a group of requests to be continuously called, based on the request relation map 2700 (Step S1103).

Specifically, the management server controller 110 generates a request pair having a cell value (difference in execution time) smaller than a threshold value, and generates a request group by grouping pairs including shared requests. The threshold value can be set to any value. A cell pair having a cell value of 0 is not generated.

Next, the management server controller 110 generates candidate request paths by sorting the requests of each of the request groups in execution order (Step S1104).

Next, the management server controller 110 starts loop processing for the candidate request paths (Step S1105).

Specifically, the management server controller 110 selects one candidate request path from among the candidate request paths generated in Step S1104.

Next, the management server controller 110 determines whether or not the candidate request path is a new request path (Step S1106).

Specifically, the management server controller 110 refers to the request path management information 400, and determines whether or not an entry in which the request path 402 matches the candidate request path exists. In a case where there is no such entry, the management server controller 110 determines that the candidate request path is a new request path.

In a case where the candidate request path is not a new request path, the management server controller 110 advances to Step S1108.

In a case where the candidate request path is a new request path, the management server controller 110 registers the candidate request path in the request path management information 400 (Step S1107), and then advances to Step S1108.

Specifically, the management server controller 110 adds an entry to the request path management information 400, and sets the identification information on the first request of the candidate request path in the request ID 401 of the added entry. Further, the management server controller 110 sets the candidate request path in the request path 402 of the added entry. In Step S1108, the management server controller 110 determines whether or not the processing is complete for all of the candidate request paths (Step S1108).

In a case where the processing is not complete for all of the candidate request paths, the management server controller 110 returns to Step S1105 and executes the same processing.

In a case where the processing is complete for all of the candidate request paths, the management server controller 110 ends the update processing for the request path management information 400.

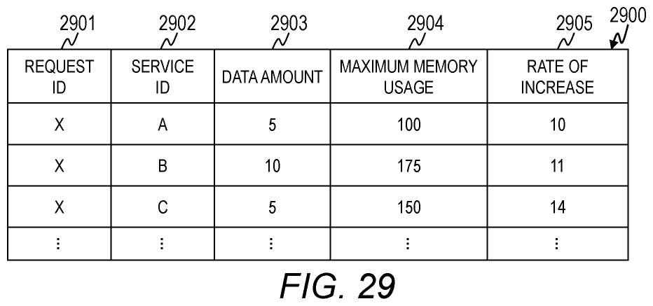

FIG. 28 is a flowchart for illustrating an example of update processing for the service load feature information 600 to be executed by the management server controller 110 in the first embodiment. FIG. 29 is a table for showing an example of a data structure of load analysis information 2900 generated by the management server controller 110 in the first embodiment.

The management server controller 110 executes the following update processing periodically or in a case where an execution instruction is received.

First, the management server controller 110 initializes the load analysis information 2900 (Step S1201).

The load analysis information 2900 stores an entry including a request ID 2901, a service ID 2902, a data amount 2903, a maximum memory usage 2904, and a rate of increase 2905.

The management server controller 110 creates the number of entries equal to the number of combinations of requests and services.

Next, the management server controller 110 starts loop processing for the combinations of requests and services (Step S1202).

Specifically, the management server controller 110 selects one entry of the load analysis information 2900.

Next, the management server controller 110 analyzes the processing node performance information 800, the service execution information 1100, and the like, and calculates the reception count of the request and the maximum value of each metric (Step S1203). Specifically, the following processing is executed.

The management server controller 110 calculates the number of requests received within a fixed time based on the service execution information 1100, and sets the calculated number of requests in the data amount 2903.

The management server controller 110 generates, based on the processing node performance information 800 and the service execution information 1100, time-series data of each metric of the service providing a function corresponding to a given request. The management server controller 110 calculates the maximum usage of the metrics based on the time-series data, and updates the load analysis information 2900. For example, a value is set in the maximum memory usage 2904.

Next, the management server controller 110 analyzes the processing node performance information 800, the service execution information 1100, and the like, and calculates the rate of increase (Step S1204).

Specifically, the management server controller 110 calculates the rate of increase based on the time from when the metric value started changing until the warning upper limit threshold value 703 is reached, and the difference between the metric value exhibited when the change started and the warning upper limit threshold value 703. The management server controller 110 sets the calculated rate of increase in the rate of increase 2905.

Next, the management server controller 110 updates the service load feature information 600 (Step S1205). Specifically, the following processing is executed.

The management server controller 110 refers to the service load feature information 600, and retrieves entry in which the combination of the request ID 601, the service ID 602, and the data amount 603 matches the combination of the request ID 2901, the service ID 2902, and the data amount 2903 of the selected entry.

In a case where there is an entry having such a match, the management server controller 110 calculates the average value of the maximum memory usage 2904 of the selected entry and the maximum memory usage 604 of the retrieved entry, and sets the calculated average value as the maximum memory usage 604 of the retrieved entry. In addition, the management server controller 110 calculates the average value of the rate of increase 605 of the selected entry and the rate of increase 2905 of the retrieved entry, and sets the calculated average value as the rate of increase 605 of the retrieved entry.

In a case where the above-mentioned entry does not exist, the management server controller 110 adds an entry to the service load feature information 600, and sets the values of the selected entry in the relevant field of the added entry. There has been provided above description of the processing of Step S1205.

Next, the management server controller 110 determines whether or not the processing is complete for all of the entries of the load analysis information 2900 (Step S1206).

In a case where the processing is not complete for all of the entries of the load analysis information 2900, the management server controller 110 returns to Step S1202 and executes the same processing.

In a case where the processing is complete for all of the entries of the load analysis information 2900, the management server controller 110 ends the update processing for the service load feature information 600.

As described above, in a case of detecting a reception of a request on the business system 102, the management server 100 estimates the load of the service to be executed as a result of receiving the request, and performs scheduling for changing the resource allocation amount. The management server 100 can change the resource allocation amount for the service in accordance with the schedule before an influence on the service becomes apparent. The management server 100 estimates the load of the service based on the reception count of the request, and therefore can also handle sudden loads.

The management server 100 identifies related services based on the calling relationship of the request and the configuration of the services providing the functions corresponding to each request. As a result, it is possible to efficiently change the resource allocation amount and minimize the influence on the overall business due to the change in the resource allocation amount.

The management server 100 may also provide an interface configured to receive designation of metrics to be used in various determinations. In the first embodiment, it is assumed that the services between requests do not overlap, but the same processing can be applied even when the services between requests overlap.

The present invention is not limited to the above embodiment and includes various modification examples. In addition, for example, the configurations of the above embodiment are described in detail so as to describe the present invention comprehensibly. The present invention is not necessarily limited to the embodiment that is provided with all of the configurations described. In addition, a part of each configuration of the embodiment may be removed, substituted, or added to other configurations.

A part or the entirety of each of the above configurations, functions, processing units, processing means, and the like may be realized by hardware, such as by designing integrated circuits therefor. In addition, the present invention can be realized by program codes of software that realizes the functions of the embodiment. In this case, a storage medium on which the program codes are recorded is provided to a computer, and a CPU that the computer is provided with reads the program codes stored on the storage medium. In this case, the program codes read from the storage medium realize the functions of the above embodiment, and the program codes and the storage medium storing the program codes constitute the present invention. Examples of such a storage medium used for supplying program codes include a flexible disk, a CD-ROM, a DVD-ROM, a hard disk, a solid state drive (SSD), an optical disc, a magneto-optical disc, a CD-R, a magnetic tape, a non-volatile memory card, and a ROM.

The program codes that realize the functions written in the present embodiment can be implemented by a wide range of programming and scripting languages such as assembler, C/C++, Perl, shell scripts, PHP, Python and Java.

It may also be possible that the program codes of the software that realizes the functions of the embodiment are stored on storing means such as a hard disk or a memory of the computer or on a storage medium such as a CD-RW or a CD-R by distributing the program codes through a network and that the CPU that the computer is provided with reads and executes the program codes stored on the storing means or on the storage medium.

In the above embodiment, only control lines and information lines that are considered as necessary for description are illustrated, and all the control lines and information lines of a product are not necessarily illustrated. All of the configurations of the embodiment may be connected to each other.

What is claimed is:

1. A computer system, comprising a plurality of computers,
the plurality of computers each including:
an arithmetic device;
a storage device coupled to the arithmetic device; and
a communication device for coupling to an external apparatus, the communication device being coupled to the arithmetic device,
the computer system including a business system including at least one of the plurality of computers, the business system being configured to operate a plurality of services each providing a function corresponding to a request,
the computer system comprising:
a controller configured to generate a schedule for changing an allocation amount of a resource of the business system for a service; and
an allocation change unit configured to change the allocation amount of the resource for the service based on the schedule,
the controller being configured to:
calculate, in a case where reception of a request for starting processing is detected, a reception count of the detected request;
identify a plurality of related services to be executed based on reception of the detected request;
calculate a predicted value of an index indicating a load of each of the plurality of related services based on the reception count of the detected request;
determine whether it is necessary to change the allocation amount of the resource for the each of the plurality of related services; and
generate the schedule of a determined related service.

2. The computer system according to claim 1, wherein the controller is configured to:
identify at least one related request issued after the detected request, and register the detected request and the at least one related request as target requests in a list;
select one of the target requests from the list;
calculate a reception count of the selected target request;
identify, as a related service, a service for providing a function corresponding to the selected target request;
calculate a predicted value of the index of the related service based on the reception count of the selected target request;
determine, based on the predicted value of the index of the related service, whether it is necessary to change the allocation amount of the resource for the related service; and
generate the schedule of the determined related service.

3. The computer system according to claim 2,
wherein the computer system is configured to hold first management information for managing a calling relationship of the request and second management information for managing a configuration of a service for providing the function corresponding to the request, and
wherein the controller is configured to:
identify the related request based on the first management information; and
identify the service for providing the function corresponding to the selected target request based on the second management information.

4. The computer system according to claim 3,
wherein the computer system is configured to hold third management information including a first threshold value for determining whether to increase an allocation amount of the resource for the service and a second threshold value for determining whether to reduce the allocation amount of the resource for the service, and
wherein the controller is configured to:
generate a resource addition schedule for increasing the allocation amount of the resource for the related service in a case where it is determined that the predicted value of the index of the related service is larger than the first threshold value; and
generate a resource reduction schedule for reducing the allocation amount of the resource for the related service in a case where it is determined that the predicted value of the index of the related service is smaller than the second threshold value.

5. The computer system according to claim 4,
wherein the computer system is configured to hold fourth management information for managing a relationship between the reception count of the request and the index of the service,
wherein the fourth management information includes a rate of increase of the resource amount used by the service to be executed in response to the reception of the request, and
wherein the controller is configured to:
calculate the predicted value of the index of the related service based on the reception count of the selected target request and the fourth management information;
calculate, in a case where it is determined that the predicted value of the index of the related service is larger than the first threshold value of the related service, a grace period indicating a period of time serving as a guide for completing addition of the allocation amount of the resource for the related service, based on a current value of the index of the related service, the predicted value of the index, and the rate of increase of the resource amount used by the related service; and
generate the resource addition schedule including the grace period, and
wherein the allocation change unit is configured to determine an execution order of a plurality of resource addition schedules based on the grace period.

6. The computer system according to claim 4, wherein the allocation change unit is configured to determine an execution order of each of the resource addition schedule and the resource reduction schedule base on an amount of free resources in the business system.

7. The computer system according to claim 4,
wherein the resource is a processing node configured to execute the service,
wherein the resource addition schedule is a schedule for increasing a number of the processing nodes executing the determined related service, and
wherein the resource reduction schedule is a schedule for reducing the number of the processing nodes executing the determined related service.

8. A resource management method to be executed by a computer system including a plurality of computers,
the plurality of computers each including:
an arithmetic device;
a storage device coupled to the arithmetic device; and
a communication device for coupling to an external apparatus, the communication device being coupled to the arithmetic device,
the computer system including a business system including at least one of the plurality of computers, the business system being configured to operate a plurality of services each providing a function corresponding to a request;
the computer system having:
a controller configured to generate a schedule for changing an allocation amount of a resource of the business system fora service; and
an allocation change unit configured to change the allocation amount of the resource for the service based on the schedule,
the resource management method including:
a first step of calculating, by the controller, in a case where reception of a request for starting processing is detected, a reception count of the detected request;
a second step of identifying, by the controller, a plurality of related services to be executed based on reception of the detected request;
a third step of calculating, by the controller, a predicted value of an index indicating a load of each of the plurality of related service based on the reception count of the detected request;
a fourth step of determining, by the controller, whether it is necessary to change the allocation amount of the resource for the each of the plurality of the each of the plurality of related services; and
a fifth step of generating, by the controller, the schedule of a determined related service.

9. The resource management method according to claim 8,
wherein the first step includes:
identifying, by the controller, at least one related request issued after the detected request, and registering the detected request and the at least one related request as target requests in a list;
selecting, by the controller, one of the target requests from the list; and
calculating, by the controller, a reception count of the selected target request,
wherein the second step includes identifying, by the controller, as a related service, a service providing a function corresponding to the selected target request,
wherein the third step includes calculating, by the controller, a predicted value of the index of the related service based on the reception count of the selected target request,
wherein the fourth step includes determining, by the controller, based on the predicted value of the index of the related service, whether it is necessary to change the allocation amount of the resource for the related service, and
wherein the fifth step includes generating, by the controller, the schedule of the determined related service.

10. The resource management method according to claim 9,
wherein the computer system is configured to hold first management information for managing a calling relationship of the request and second management information for managing a configuration of a service for providing the function corresponding to the request,
wherein the first step includes identifying, by the controller, the related request based on the first management information, and
wherein the second step includes identifying, by the controller, the service for providing the function corresponding to the selected target request based on the second management information.

11. The resource management method according to claim 10,
wherein the computer system is configured to hold third management information including a first threshold value for determining whether to increase an allocation amount of the resource for the service and a second threshold value for determining whether to reduce the allocation amount of the resource for the service, and
wherein the fifth step includes:
generating, by the controller, a resource addition schedule for increasing the allocation amount of the resource for the related service in a case where it is determined that the predicted value of the index of the related service is larger than the first threshold value; and
generating, by the controller, a resource reduction schedule for reducing the allocation amount of the resource for the related service in a case where it is determined that the predicted value of the index of the related service is smaller than the second threshold value.

12. The resource management method according to claim 11,
wherein the computer system is configured to hold fourth management information for managing a relationship between the reception count of the request and the index of the service,
wherein the fourth management information includes a rate of increase of the resource amount used by the service to be executed in response to the reception of the request, and
wherein the third step includes:
calculating, by the controller, the predicted value of the index of the related service based on the reception count of the selected target request and the fourth management information;
wherein the fifth step includes:
calculating, by the controller, in a case where it is determined that the predicted value of the index of the related service is larger than the first threshold value of the related service, a grace period indicating a period of time serving as a guide for completing addition of the allocation amount of the resource for the related service, based on a current value of the index of the related service, the predicted value of the index, and the rate of increase of the resource amount used by the related service; and
generating, by the controller, the resource addition schedule including the grace period, and
wherein the resource management method further includes determining, by the allocation change unit, an execution order of a plurality of resource addition schedules based on the grace period.

13. The resource management method according to claim 11, further including a step of determining, by the allocation change unit, an execution order of each of the resource addition schedule and the resource reduction schedule based on an amount of free resources in the business system.

14. The resource management method according to claim 11,
wherein the resource is a processing node configured to execute the service,
wherein the resource addition schedule is a schedule for increasing a number of the processing nodes executing the determined related service, and
wherein the resource reduction schedule is a schedule for reducing the number of the processing nodes executing the determined related service.
